(19) United States
(12) Patent Application Publication
(10) Pub. No.: US 2014/0186033 A1
(43) Pub. Date: Jul. 3, 2014

(54) SECURE DATA TRANSMISSION VIA SPATIALLY MULTIPLEXED OPTICAL SIGNALS

(71) Applicant: Alcatel-Lucent USA Inc., Murray Hill, NJ (US)

(72) Inventors: Peter J. Winzer, Aberdeen, NJ (US); Kyle C. Guan, Aberdeen, NJ (US); Emina Soljanin, Green Village, NJ (US)

(73) Assignee: Alcatel-Lucent USA Inc., Murray Hill, NJ (US)

(21) Appl. No.: 13/730,270

(22) Filed: Dec. 28, 2012

(51) Int. Cl. H04B 10/85

(52) U.S. Cl. CPC H04B 10/85
USPC 398/39

(57) ABSTRACT

Various embodiments provide secure optical transmission of data. Noise may be added to optical signals transmitted by spatial paths of a multimode optical fiber. The noise may be added electrically prior to modulation, or optically after modulation. In some embodiments a transmitter and a receiver cooperate to maintain a noise level sufficient to place a tapped signal in a noise regime that provides a predetermined level of data security.

### CROSS-REFERENCE TO RELATED APPLICATIONS

The application is related to U.S. patent application Ser. No. 13/730,131 (attorney docket 812068), filed on even date herewith and incorporated by reference in its entirety.

### TECHNICAL FIELD

The disclosure relates generally to optical communications.

### BACKGROUND

Optical communications systems provide data transmission paths that are generally robust to interception of information, e.g. eavesdropping. However, under some circumstances an eavesdropper may tap information from the transmission path, e.g. an optical fiber. Such eavesdropping may be difficult to detect, leaving the intended recipient of the transmission unaware that the confidentiality of the transmission has been compromised.

### SUMMARY

One embodiment provides a first system, e.g. for securely transmitting optical data. The first system includes an optical fiber capable of supporting a spatially multiplexed optical signal (e.g., a multi-core or a multi-mode fiber), and a mode-selective multiplexer configured to condition each of a plurality of optical signals for transmission, e.g. orthogonal transmission, via a corresponding spatial mode of the optical fiber. A noise source is configured to add a noise signal to one or more of the optical signals.

Any embodiment of the first system may include a modulator configured to modulate each of the optical signals with transmission data, wherein the noise is added to an optical source of the modulator. In any embodiment the noise source may add noise to the one or more optical signals after the one or more optical signals are modulated with transmission data. In any embodiment the noise source may add electrical noise, e.g. in analog or digital form, to a digital data stream before the optical source is modulated with the digital data stream. In some such embodiments the electrical noise may comprise a bit stream produced by a pseudo-random cipher algorithm.

In another embodiment the disclosure provides a second system, e.g. for optically transmitting secure data. The second system includes an optical transmitter and an optical receiver. An optical fiber capable of supporting a spatially multiplexed optical signal is configured to convey a transmission of data from the transmitter to the receiver. The transmitter is configured to set a signal-to-noise ratio (SNR) or a transmission capacity to achieve a predetermined secrecy capacity of the transmission.

In any embodiment of the second system, the secrecy capacity may be determined from a difference between a data capacity of a legitimate data channel transmitted via the optical fiber, and an estimated data capacity of an optical signal tapped from the optical fiber. In any embodiment of the second system the receiver may be configured to provide a measure of optical channel signal parameters to the transmitter. In some embodiments of the second system, instead of or in addition to the parameter measurement at the receiver, the transmitter may be configured to estimate a measure of the channel signal parameters as received by the receiver.

Another embodiment provides a third system, e.g. for optically transmitting secure data. The third system includes an optical transmitter, an optical receiver, and an optical fiber capable of supporting a spatially multiplexed optical signal, the optical fiber configured to convey data via a transmitted optical signal from the transmitter to the receiver. The transmitter is configured to set a signal-to-noise ratio (SNR) of the transmitted signal to place an eavesdropper in one of a plurality of predetermined security regions of the transmitted data.

In any embodiment of the third system the plurality of security regions may include an exponentially secure region. In any embodiment of the third system the receiver may be configured to estimate the channel quality of an optical signal tapped from the optical fiber. In such embodiments the receiver may be configured to estimate the mode-dependent loss of the tapped optical signal.

Another embodiment provides a fourth system, e.g. for optically transmitting secure data. This system includes a optical fiber capable of supporting a spatially multiplexed optical signal, a transmitter and a receiver. The transmitter includes a mode scrambler configured to receive a plurality of optical data channels having an original order at a corresponding plurality of inputs and to reorder the received optical data channels among a corresponding plurality of outputs for transmission over the optical fiber. The mode scrambler is configured to preserve orthogonality among the spatially multiplexed signals, i.e., it essentially represents a unitary spatial transformation. The receiver includes a mode descrambler configured to receive the reordered data channels from the optical fiber and recover the original order.

In any embodiment of the fourth system the mode scrambler and mode descrambler may share a pseudo-random scrambling schedule. In any embodiment of the fourth system data transmission may include a start-up phase during which the transmitter transmits the plurality of optical data channels without reordering. In any embodiment of the fourth system the optical fiber may be a multi-core optical fiber. In any embodiment of the fourth system the receiver may perform MIMO processing of the received optical data channels.

Additional aspects of the invention will be set forth, in part, in the detailed description, figures and any claims which follow, and in part will be derived from the detailed description, or can be learned by practice of the invention. It is to be understood that both the foregoing general description and the following detailed description are examples and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 illustrates a prior art optical transmission system;

FIG. 2 illustrates several characteristics of secrecy capacity of a transmitted optical data signal vs. the signal-to-noise ratio of an optical signal tapped by an eavesdropper;

FIG. 3 illustrates in a first embodiment a system, e.g. for secure optical data transmission, in which noise is added to one or more optical signal paths via an amplifier-attenuator pair to decrease the SNR of the one or more optical signals;

FIG. 4 illustrates in a second embodiment a system, e.g. for secure optical data transmission, in which noise is added to one or more digital signal paths prior to modulation of an optical carrier;

FIG. 5 illustrates in a third embodiment a system, e.g. for secure optical data transmission, in which noise is added to one or more optical signal paths, e.g. by adding optical signal noise;

FIG. 6A illustrates an embodiment of a system, e.g. for secure optical data transmission, in which a transmitter and a receiver may cooperate to operate at a predetermined secrecy capacity of the optical transmission;

FIG. 6B illustrates an embodiment of the system of FIG. 6A, in which data may be transmitted securely by a correlation between logical states of pseudorandom bits transmitted via two spatial paths of a spatially multiplexing fiber;

FIGS. 7A and 7B illustrate methods, e.g. for secure optical transmission of data, that may be employed by the system of FIG. 6A;

FIG. 8 illustrates aspects of various security levels that may be attained with different levels of channel quality of a tapped optical signal; and

FIG. 9 illustrates a system, e.g. for secure optical transmission of data, in which orthogonality preserving, spatially unitary mode scrambling may be used to prevent an eavesdropper from properly interpreting a tapped optical signal.

### DETAILED DESCRIPTION

The disclosure is directed to, e.g. methods and systems that provide improved security of optical communications. The inventors have discovered that a spatially diverse optical transmission medium, e.g. an optical fiber capable of supporting spatially multiplexed optical signal, e.g. a multimode or multi-core optical fiber, may provide greater security of data than conventional transmission media, e.g. a single-mode optical fiber. Because optical signals propagating in such a spatially diverse medium have modal relationships that typically remain relatively constant during transmission, data interception by an eavesdropper may be denied by, e.g. ensuring that the eavesdropper is unable to properly reconstruct these relationships in tapped optical signals.

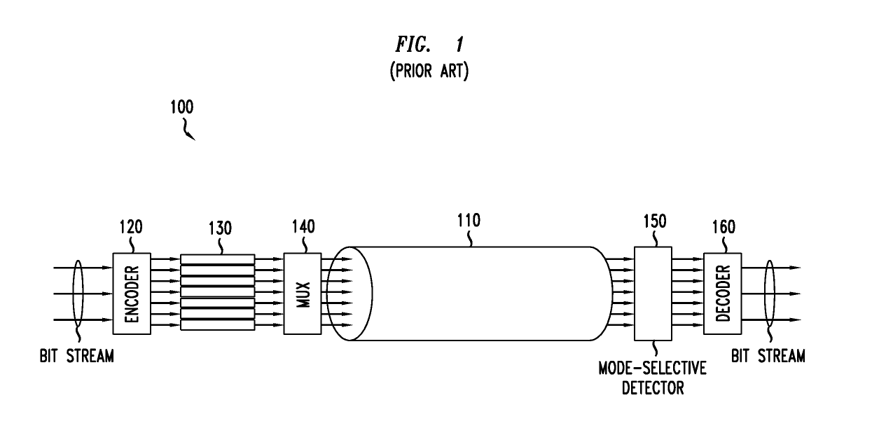

FIG. 1 schematically illustrates a conventional spatially multiplexed optical transmission system 100. The system 100 includes an optical fiber 110 that is capable of supporting spatially multiplexed optical signal, e.g. a multimode or multi-core fiber. The term “spatially-multiplexing fiber, sometimes referred to as “SMF”, when used without elaboration, is not limited to either fiber type. The fiber 110 is capable of supporting multiple propagation modes, e.g. orthogonal modes of a basis set of propagation modes.

An encoder 120 receives data from an unreferenced bit stream, e.g. as three-bit-wide encoded data, and converts the received data to a number of serial bit streams. One each of a corresponding number of modulators 130 receives each serial bit stream and converts the received bit stream to an optical signal by modulating an optical carrier, e.g. a laser output (not shown). Each modulator 130 may include a digital-to-analog converter (DAC), not shown, to convert the received bit stream to an analog signal prior to modulating an optical carrier, e.g. a constant wave (CW) laser output. A mode-selective multiplexer 140, sometimes briefly referred to as the multiplexer 140, receives the optical signals and forms a corresponding number of mode-shaped optical signals for input to the fiber 110. See, e.g., U.S. Pat. No. 8,320,769, incorporated herein by reference. The mode-shaped signals have mode relationships that are determined to support propagation within the fiber 100. Notably, the mode-shaped signals are spatially orthogonal when launched into the fiber. While the optical signals may change in some aspects, e.g. intensity, as the signals propagate, the mode characteristics, e.g. relative intensity and phase, are expected to remain nearly constant as the signals propagate.

A mode-selective detector 150 receives the mode-shaped signals and produces a number of optical signals having serial data modulation. A decoder 160 receives the serial optical data streams and reforms output encoded data.

If the fiber 110 is tapped, e.g. to intercept data, some energy from one or more of the propagating modes therein will be removed from the propagating signal. The reduction of the energy propagating in the one or more modes will typically result in a change of the relative modal properties of the optical channels propagating in the fiber 110.

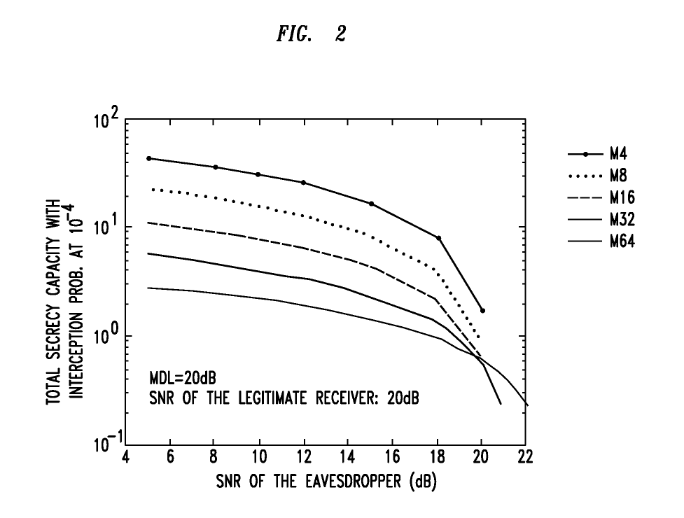

FIG. 2 illustrates transmission characteristics referred to as “total secrecy capacity” (TSC) as a function of a signal-to-noise (SNR) of a presumed eavesdropper determined by data transmission simulations. The TSC refers to the data-carrying capacity of the fiber 110 (in normalized arbitrary units) at which there is high confidence that the secrecy of the transmitted data is assured. In the present nonlimiting example the probability of interception is 0.01%. Five nonlimiting example cases are shown, from 4 propagating modes (bottom characteristic) through 64 propagating modes (topmost characteristic). A receiver SNR of 20 dB is assumed without limitation. Each one of the TSC characteristics decreases as the SNR of the presumed eavesdropper increases. For all the illustrated characteristics, the secrecy capacity of the fiber 110 decreases with increasing SNR of the eavesdropper. In other words, as the quality of the signals tapped by the eavesdropper increases the secrecy capacity of the fiber 110 decreases.

Thus, in some embodiments the secrecy capacity of the fiber may be maintained at a relatively high level by ensuring that the eavesdropper's SNR is relatively low compared to the receiver. In other words, the SNR along the optical communication path may be designed to ensure that the SNR of an eavesdropper is never more than a predetermined proportion of the receiver SNR, e.g. never more than about 50% of the receiver SNR. Noise may be added to the transmitted signal by any conventional or future-discovered manner. Moreover, the noise may be added at any location between the optical transmitter and the eavesdropping optical receiver as determined to meet the objective of reducing the SNR of the eavesdropper as compared to the SNR of the receiver. The figures described immediately following provide three nonlimiting examples. Those skilled in the art may apply the principles described herein in other specific embodiments within the scope of the disclosure and the claims.

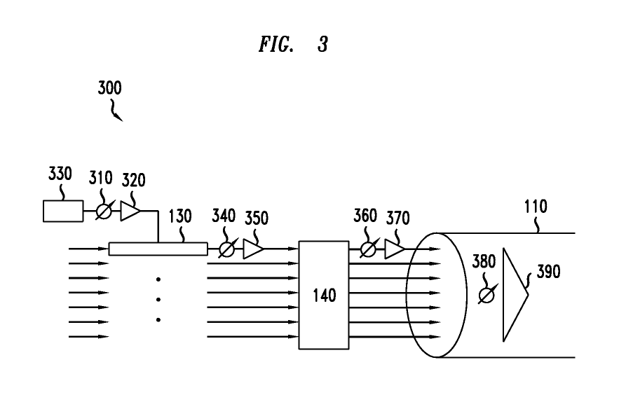

FIG. 3 illustrates an embodiment of a system 300 in which noise, e.g. analog noise, is added to the transmitted optical signal by one or more amplifiers, each of which may optionally be paired with a corresponding attenuator. As appreciated by those skilled in the art, an optical amplifier may add an incremental amount of noise, e.g. Gaussian noise, to the optical signal. In some embodiments the amplifier may be intentionally designed to have a greater amount of noise than might be used in a low-noise application. Such an amplifier may be referred to herein as a “noisy amplifier”. When a noisy amplifier is paired with an attenuator, the attenuator and the amplifier may have reciprocal gains with respect to each other, but this need not be the case.

In a first example, an attenuator 310 and amplifier 320 add noise to an optical signal initially output by a laser 330. The signal, referred to as a noise signal after output by the amplifier 320, is added to an optical signal received by one of the modulators 130. In various embodiments a noise signal may be added to one, some less than all, or all of the optical signals received by the modulators 130. In a second example, the noise is added between one of the modulators 130 and the multiplexer 140 via an attenuator 340 and an amplifier 350. Again, the pair 340/350 may be placed before one, some or all of the inputs to the multiplexer 140. In a third example, the noise is added between one of the outputs of the multiplexer 140 and the fiber 110 via an attenuator 360 and an amplifier 370. Again, the pair 360/370 may be placed after one, some or all of the inputs to the multiplexer 140. Finally, noise may be added by direct amplification via the fiber, symbolized by a spatially multiplexing attenuator 380 and amplifier 390. Such devices are known in the art.

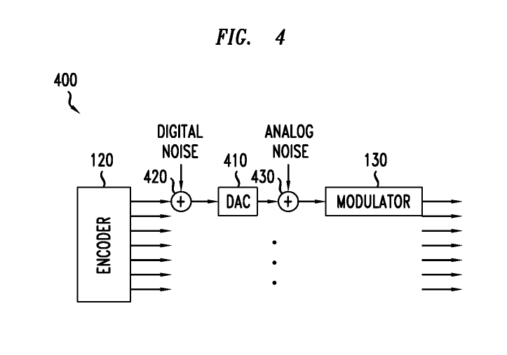

FIG. 4 illustrates an embodiment of a system 400 in which electronic noise, e.g. digital noise, may be added to the transmitted signal prior to optical modulation. Such noise addition may be thought of as creating a noisy constellation, e.g. a noisy 16-, 32- or 64-QAM constellation. The system 400 includes the encoder 120 and an instance of the modulator 130, both previously described. Also separately shown is a DAC 410 which may be a functional portion of the modulator 130.

A first summing node 420 receives a channel output from the encoder 120 and an unreferenced digital noise source. A second summing node 430 receives the output of the DAC 410 and an unreferenced analog noise source. The modulator 130 receives the output of the second summing node 430. In various embodiments one or both the summing nodes 420, 430, and their respective noise sources, are present. In this manner, digital noise, analog noise, or both may be added to the bit stream from the encoder 120 before modulation of the channel optical signal.

The analog noise source provides the ability to add analog noise, e.g. colored or white Gaussian noise, to the analog signal used to modulate the optical channel. The digital noise source provides the ability to add digital noise to the data stream prior to conversion to the analog domain. The digital noise source may provide noise similar to the analog noise source, e.g. digital representations of colored or white Gaussian noise, or may provide correlated “noise”, e.g. a bit stream produced by a pseudo-random cipher algorithm such as the advanced encryption standard (AES) cipher. Such use of a cipher may provide a security layer to the modulated optical signal, making interpretation less likely in the event of successful interception by an unintended recipient. In such cases, the eavesdropper may not be able to distinguish the correlated noise from uncorrelated (e.g. Gaussian) noise. But the intended recipient, with a properly synchronized receiver and in possession of an appropriate key, may remove the correlated noise to recover the transmitted data.

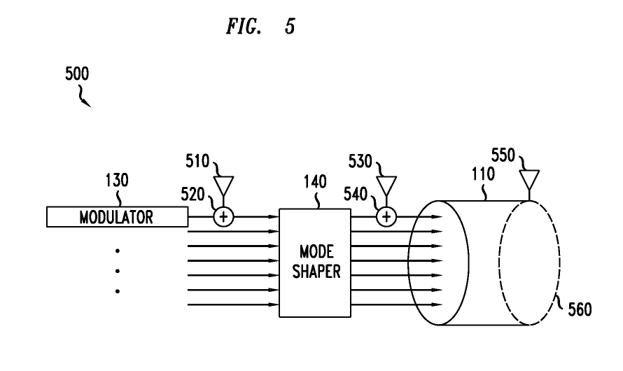

FIG. 5 illustrates an embodiment of a system 500 in which noise, e.g. analog noise, may be added optically to the transmitted signal after optical modulation. Three examples are shown. In a first example noise produced by an optical amplifier 510 may be added via a summing node 520 to the output of the modulator 130. In a second example noise produced by an optical amplifier 530 may be added via a summing node 540 to the output of the multiplexer 140. In a third example noise produced by an optical amplifier 550 may be directly injected into the spatially multiplexing fiber 560. Various embodiments may include none, some or all of these three examples. The optical noise inputs may be selected to add noise specifically at one or more optical wavelengths, or may be broad-band.

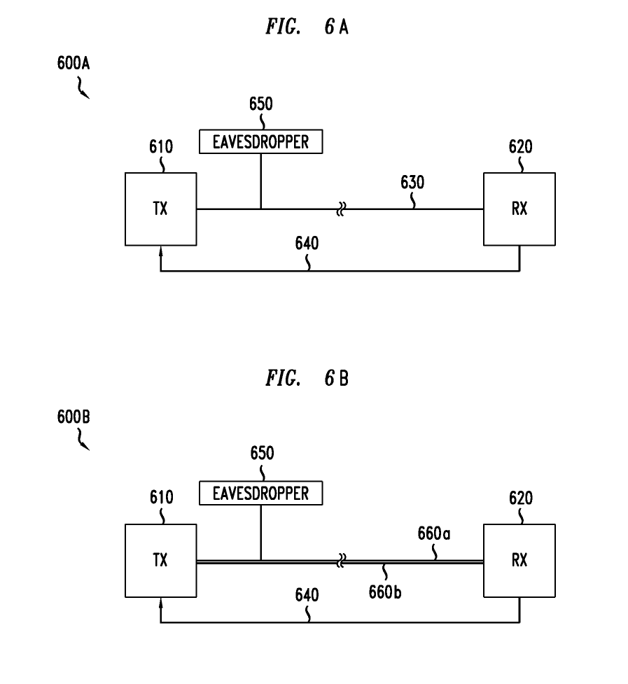

FIG. 6A illustrates aspects of another embodiment for secure optical transmission. FIG. 6A includes a transmitter (TX) 610 and a receiver (RX) 620 connected by an optical fiber 630. An optional feedback path 640 provides information from the RX 620 to the TX 610 regarding signal parameters at the RX 620, e.g. power and/or mode-dependent loss (MDL). An eavesdropper 650 taps the optical fiber 630.

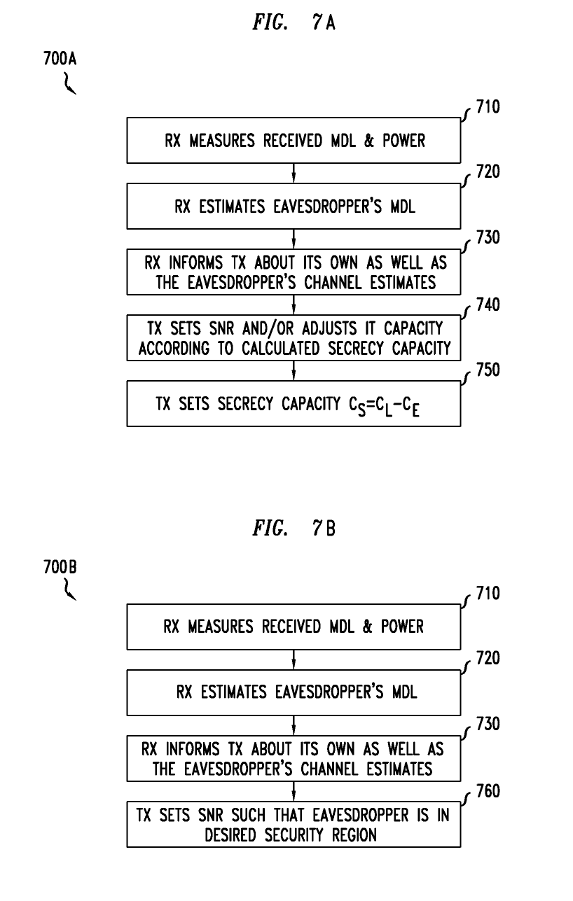

FIG. 7A presents one embodiment of a method 700A, e.g. for operating the system 600A. In a step 710 the RX 620 measures MDL and power of the received optical signal. In a step 720 the RX 620 estimates the MDL of the optical signal received by the eavesdropper. This estimate may be based on, e.g. a singular value decomposition of the estimated channel matrix. See, e.g. Peter Winzer and Gerard Foschini, “MIMO Capacities and Outage Probabilities in Spatially Multiplexed Optical Transport Systems”, Optics Express, Vol. 19, Issue 17, pp. 16680-16696 (2011), incorporated herein by reference. In a step 730 the RX 620 provides these values to the TX 610 via the feedback path 640. In some embodiments the TX 610 estimates the power and MDL at the RX 620 based on, e.g. an optical time-domain reflectrometric measurement from which the MDL is extracted using, e.g., the singular value decomposition referenced above. In such embodiments the feedback path 640 may be eliminated. In a step 740 the TX 610 calculates a secrecy capacity C. The secrecy capacity is defined as the maximum transmission data rate at which the TX 610 may transmit with high confidence that the eavesdropper is unable to determine the transmitted data from the tapped optical signal. See, e.g. Kyle Guan, et al., Information-Theoretic Security in Space-Division Multiplexed Fiber Optic Networks, ECOC, Jun. 16, 2012, incorporated herein by reference. In this context “high confidence” means a confidence of at least about 99%. In some embodiments C_{S}=C_{L}−C_{E}, where C_{L} is the data capacity of the legitimate data channel, e.g. the optical fiber 630, and C_{E} is the estimated data capacity of the eavesdropper's signal tap. Typically if the TX data rate is less than about C_{S}, then the confidence that the transmitted data cannot be intercepted may be at least about 99.99%. In other words, in such circumstances the eavesdropper is expected to have a chance no greater than about 1E−5 of successfully intercepting the transmitted data. See, e.g. Gaun, et al., supra. In a step 750 the TX 610 sets and/or adjusts its transmitted data capacity to be about equal to the calculated C.

FIG. 7B illustrates a method 700B in which the TX 610 and the RX 620 negotiate a data transmission rate that results in a high confidence that an eavesdropper cannot intercept the data. Steps 710, 720 and 730 are as previously described. In a step 760 the TX 610 determines a transmission data rate that results in a desired level of security.

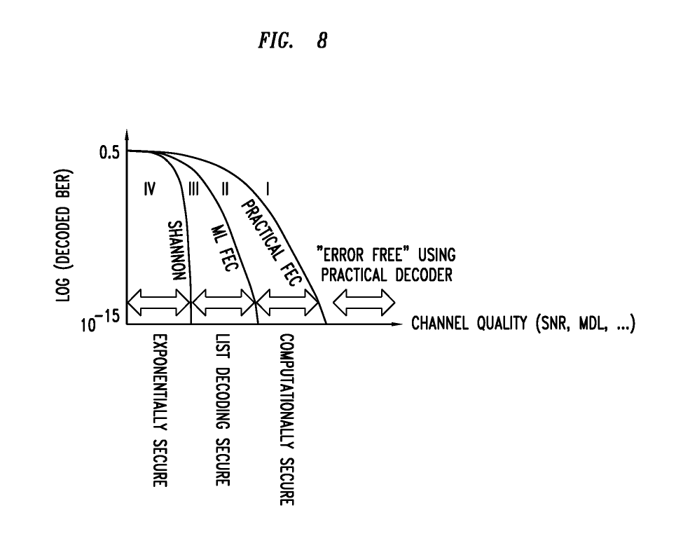

The level of security is described with reference to FIG. 8. FIG. 8 includes 4 regions I, II, III and IV that are divided by curves of decoded bit error ratio (BER) versus channel quality (as quantified by SNR, MDL, and the like) for various decoding (or forward error correction, FEC) techniques, e.g. practical FEC, maximum likelihood (ML) FEC, and Shannon limit FEC. If the channel quality for the eavesdropper is good enough to decode at the desired BER (region I), the eavesdropper may decode the tapped signal with high confidence, referred to without limitation as “error-free” using practical (e.g. relatively simple) FEC decoding. If the tapped channel quality is below the practical FEC limit, but above the ML FEC limit (region II), then the data transmission may be considered “computationally secure”, meaning e.g. that the computational cost of decoding the tapped signal may be computationally prohibitive for the eavesdropper. If the tapped channel quality is below the ML limit, but above the “Shannon” limit (region III), then the data transmission may be considered “list decoding secure”, meaning e.g. that the eavesdropper may attempt to perform FEC using various combinations of flipped input bits and an exhaustive trial-and-error search on a long list of possible solutions. However the computational barrier of this approach is expected to be even greater than needed to decode data in region II. Below the Shannon limit (region IV) it is expected that the data transmission is “exponentially secure”, e.g. meaning the eavesdropper can do nothing better than pure guessing.

In the step 760 the TX 610 determines a transmission rate that places the eavesdropper's BER in one of the regions I, II, III or IV. In this manner the data throughput of the transmission system 600 may be established to achieve a predetermined level of security given the presumed or determined presence of the eavesdropper.

In the embodiments described above, it is assumed that the eavesdropper is able to properly estimate its channel matrix. Some embodiments impede the eavesdropping receiver's ability to determine its channel matrix to reduce the eavesdropper's ability to successfully intercept data. This strategy may be used independent of or in combination with other embodiments described herein. The following describes such embodiments.

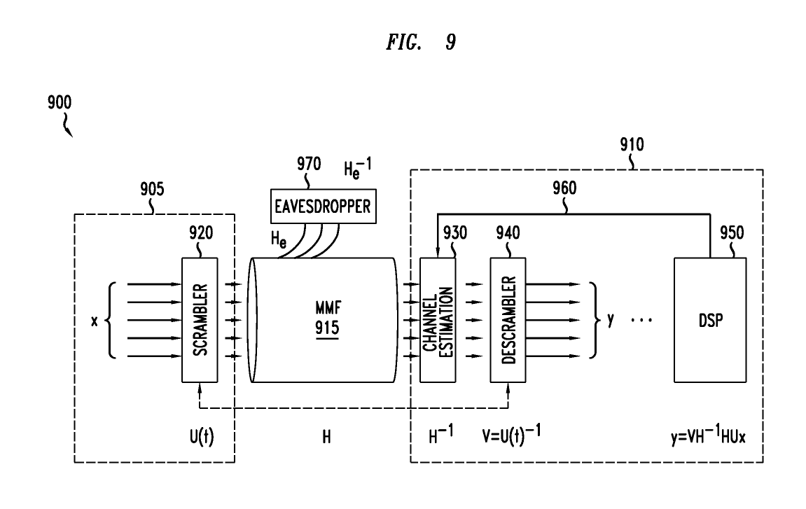

Referring to FIG. 9, a system 900 is illustrated for, e.g. secure optical communication between a transmitter 905 and a receiver 910 via a spatially multiplexing fiber 915. Data may be transmitted over fiber 915 via the spatial modes of the fiber 915 by launching signals orthogonally into the fiber. The system 900 includes a essentially spatially unitary mode scrambler 920, e.g. that is essentially spatially unitary, a channel estimator 930, a mode descrambler 940 and a receiver digital signal processor (DSP) 950. The DSP 160 may communicate with the channel estimator 930 via a feedback path 960 to dynamically adjust the channel estimation. An eavesdropper 970 may extract one or more of the spatial modes of the fiber 915 to attempt to intercept data.

The mode scrambler 920 receives optical channels, e.g. from the modulators 130 (FIG. 1) to be orthogonally coupled to corresponding spatial paths of the fiber 915. The mode scrambler 920 may operate on a pseudo-random scrambling schedule known only to the scrambler 920 (at the legitimate transmitter 905) and the descrambler 930 (at the legitimate receiver 910). The mode scrambling provided by the mode scrambler 920 may be reversed by the descrambler 940, making the transmitted data available to the receiver. However, if the scrambling schedule is hidden from the eavesdropper 970 he may not properly estimate, and hence properly invert, the channel to obtain useful information.

In some embodiments the mode scrambling takes place at a time scale that is faster than the time needed for channel estimation. In this manner, eavesdropper may be prevented from properly estimating the channel, thereby preventing decoding of the scrambled data. The rate of mode scrambling is not limited to any particular value, but in one example, may be faster than about 1E6 modulation symbols.

In FIG. 9, a scrambling function U(t) imposed by the scrambler 920 can be implemented optically or electronically using known methods. In the event that coupling between the spatial modes of the fiber 915 is weak, the receiver 910 may not require multiple-input multiple output (MIMO)-DSP processing to recover the transmitted data. In such cases, a descrambling function V(t) provided by the descrambler 940 can be implemented in optics or in electronics. If instead the legitimate channel requires MIMO-DSP at the receiver 910, e.g. due to significant coupling between legitimate SDM paths, then the descrambling function V(t) should be implemented electronically, e.g. by the DSP 950, after the channel estimator 930 applies an estimated inverse channel matrix H⁻¹. Some embodiments may include an optional start-up phase during which the transmitter and the receiver do not scramble/descramble the modes. This may allow the legitimate receiver to acquire a first estimate of a channel matrix H imposed by the fiber 915 in a static channel environment.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A system, comprising:
a spatially multiplexing optical fiber;
a mode-selective multiplexer configured to condition each of a plurality of optical signals for transmission via a corresponding spatial mode of the optical fiber; and
a noise source configured to add a noise signal to one or more of the optical signals.

2. The system of claim 1, further comprising a modulator configured to modulate each of the optical signals with transmission data, wherein the noise is added to an optical source of the modulator.

3. The system of claim 1, wherein the noise source adds electrical noise to the one or more optical signals after the one or more optical signals is modulated with transmission data.

4. The system of claim 1, wherein the noise source adds electrical noise to a digital data stream before a corresponding optical signal is modulated with the digital data stream.

5. The system of claim 4, wherein the electrical noise comprises a bit stream produced by a pseudo-random cipher algorithm.

6. A system, comprising:
an optical transmitter;
an optical receiver; and
a optical fiber capable of supporting a spatially multiplexed optical signal, the optical fiber being configured to convey a transmission of data from the transmitter to the receiver,
wherein the transmitter is configured to set a signal-to-noise ratio (SNR) or a transmission capacity to achieve a predetermined secrecy capacity of the transmission.

7. The system of claim 6, wherein the secrecy capacity is determined from a difference between a data capacity of a legitimate data channel transmitted via the optical fiber, and an estimated data capacity of an optical signal tapped from the optical fiber.

8. The system of claim 6, wherein the receiver is configured to provide a measure of optical channel signal parameters to the transmitter.

9. The system of claim 6, wherein the transmitter is configured to estimate a measure of optical channel signal parameters as received by the receiver.

10. A system, comprising:
an optical transmitter;
an optical receiver;
a optical fiber capable of supporting a spatially multiplexed optical signal, the optical fiber being configured to convey data via a transmitted optical signal from the transmitter to the receiver,
wherein the transmitter is configured to set a signal-to-noise ratio (SNR) of the transmitted signal to place an eavesdropper in one of a plurality of predetermined security regions of the transmitted data.

11. The system of claim 10, wherein the plurality of security regions includes an exponentially secure region.

12. The system of claim 10, wherein the receiver is configured to estimate the channel quality of an optical signal tapped from the multimode optical fiber.

13. The system of claim 12, wherein the receiver is configured to estimate the mode-dependent loss of the tapped optical signal.

14. A system, comprising:
a optical fiber capable of supporting a spatially multiplexed optical signal;
a transmitter including a mode scrambler configured to receive a plurality of optical data channels having an original order at a corresponding plurality of inputs and to reorder the received optical data channels among a corresponding plurality of outputs for transmission over the optical fiber; and
a receiver including a mode descrambler configured to receive the reordered data channels from the optical fiber and recover the original order.

15. The system of claim 14, wherein the mode scrambler and mode descrambler share a pseudo-random scrambling schedule.

16. The system of claim 14, wherein data transmission includes a start-up phase during which the transmitter transmits the plurality of optical data channels without reordering.

17. The system of claim 14, wherein the optical fiber is a multi-core optical fiber.

18. The system of claim 14, wherein the spatially multiplexing optical fiber is a multi-mode optical fiber.

19. The system of claim 14, wherein the receiver performs MIMO processing of the received optical data channels.
